(19) United States
(12) Patent Application Publication
(10) Pub. No.: US 2012/0307012 A1
(43) Pub. Date: Dec. 6, 2012

(54) ELECTRONIC DEVICE MOTION DETECTION AND RELATED METHODS

(76) Inventor: Shawn Porter, Saint Cloud, FL (US)

(21) Appl. No.: 13/486,080

(22) Filed: Jun. 1, 2012

Related U.S. Application Data
(60) Provisional application No. 61/493,660, filed on Jun. 6, 2011.

(51) Int. Cl. H04N 5/225; H04N 13/02

(52) U.S. Cl. 348/46; 348/169; 348/E05.024; 348/E13.074

(57) ABSTRACT

An electronic device may include an optical source generating an optical output, a lens cooperating with the optical source and projecting a grid optical pattern from the optical output, and a video sensor detecting changes in the grid optical pattern caused by movement of an object.

### RELATED APPLICATIONS

This application is based upon prior filed copending provisional application Ser. No. 61/493,660 filed Jun. 6, 2011, the entire subject matter of which is incorporated herein by reference in its entirety.

### FIELD OF THE INVENTION

The present invention relates to the field of motion detection, and, more particularly, to detecting object movement and related methods.

### BACKGROUND OF THE INVENTION

Motion detection is the activity of detecting changes in the position of one or more objects. The simplest motion detectors sense movement or the lack thereof. More advanced motion detectors further sense magnitude and direction of the object's movement. The typical electronic motion detector may be based upon any number of detection methods, such as sound, opacity, geomagnetism, reflection of transmitted energy, electromagnetic induction, and vibration.

A typical application for motion detectors is for surveillance and security. One drawback to typical motion detectors in these applications is that they may provide little characteristics about the object being detected.

### SUMMARY OF THE INVENTION

In view of the foregoing background, it is therefore an object of the present invention to provide a motion detector that is easy to use.

This and other objects, features, and advantages in accordance with the present invention are provided by an electronic device that may comprise at least one optical source generating an optical output, and at least one lens cooperating with the at least one optical source and projecting a grid optical pattern from the optical output. The electronic device may further comprise a video sensor detecting changes in the grid optical pattern caused by movement of an object. Advantageously, the electronic device may readily detect movement of the object.

More specifically, the grid optical pattern may comprise a plurality of cells arranged in columns and rows. In some embodiments, the electronic device may further comprise a processor cooperating with the video sensor to determine at least one characteristic of the object based upon the changes in the grid pattern. Also, the processor may determine a three-dimensional model of the object based upon the changes in the grid pattern.

Additionally, the at least one lens may comprise a plurality of lenses arranged along an optical path. The plurality of lenses may comprise a focusing lens adjacent the at least one optical source, a multiplier diffraction lens, and a shape diffraction lens between the focusing lens and the multiplier diffraction lens.

In other embodiments, the at least one optical source may comprise a plurality of aligned optical sources, and the at least one lens may comprise a corresponding plurality of focusing lens, each focusing lens adjacent a respective optical source from the plurality thereof. For example, the at least one optical source may comprise a laser optical source.

Moreover, the electronic device may further comprise a housing carrying the at least one optical source, the at least one lens, and the video sensor, and a power source coupled to the at least one optical source and the video sensor, and also carried by the housing. The electronic device may also include a switch mounted onto an external surface of the housing and selectively disconnecting the power source.

Another aspect is directed to an electronic device that may comprise at least one optical source generating an optical output, and a focusing lens adjacent the at least one optical source. The electronic device may include multiplier diffraction and shape diffraction lenses cooperating with the at least one optical source and the focusing lenses to project a grid optical pattern from the optical output.

Another aspect is directed to a method of detecting movement with an electronic device. The method may comprise using at least one optical source in the electronic device for generating an optical output, and using at least one lens in the electronic device for cooperating with the at least one optical source and projecting a grid optical pattern from the optical output. The method may include using a video sensor in the electronic device for detecting changes in the grid optical pattern caused by movement of an object.

Another aspect is directed to a method of operating movement with an electronic device. The method may include using at least one optical source to generate an optical output, and using a focusing lens adjacent the at least one optical source, and multiplier diffraction and shape diffraction lenses cooperating with the at least one optical source and the focusing lenses to project a grid optical pattern from the optical output.

### BRIEF DESCRIPTION OF THE DRAWINGS

FIG. 1 is a schematic diagram of an electronic device, according to the present invention.

FIGS. 2-3 are detailed schematic diagrams of an electronic device, according to the present invention.

FIG. 4 is a schematic diagram of a perspective view of an electronic device, according to the present invention.

FIG. 5 is a schematic diagram of another embodiment of an electronic device, according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

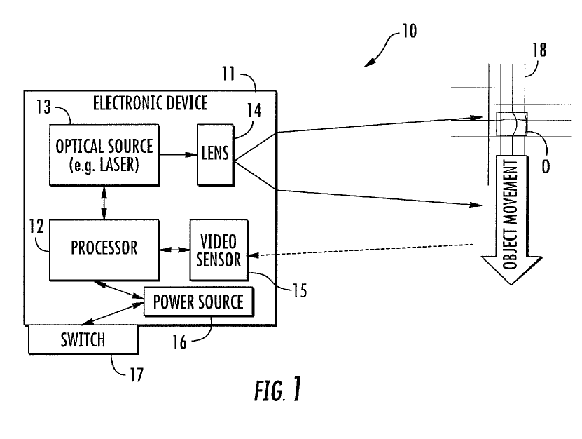

Referring initially to FIG. 1, an electronic device 10 according to the present invention is now described. The electronic device 10 illustratively includes a housing 11, an optical source (e.g. laser diode optical source) 13 generating an optical output and carried by the housing, and a lens 14 carried by the housing, cooperating with the optical source, and projecting a grid optical pattern 18 from the optical output.

The electronic device 10 illustratively includes a video sensor 15 carried by the housing 11 and detecting changes (e.g. distortions such as fading, warping, bending, etc.) in the grid optical pattern 18 caused by movement of an object O. The electronic device 10 illustratively includes a processor 12 carried by the housing 11 and cooperating with the video sensor 15 to determine at least one characteristic of the object O based upon the changes in the grid pattern 18.

More specifically, in advantageous embodiments, the processor 12 may determine a three-dimensional model of the object O based upon the changes in the grid pattern 18. In embodiments where a square celled grid is used for the grid pattern 18, the processor 12 uses the distortions detected in the grid to provide a computer-aided design (CAD) drawing of the object O.

In the illustrative embodiment of FIG. 1, the video sensor 15 and the processor 12, and the optical source 13 are carried by the same housing 11. In other embodiments, the video sensor may be a separate device with a separate housing (not shown). For example, the video sensor 15 may be provided by a typical video camera, the output thereof being transmitted to the processor 12, using a cable or a wireless connection (e.g. Bluetooth, Wi-Fi).

Moreover, the electronic device 10 illustratively includes a power source 16 carried by the housing 11. For example, the power source 16 may comprise a battery. The power source 16 is coupled to the optical source 13 and the video sensor 15. The electronic device 10 also illustratively includes a switch 17 mounted onto an external surface of the housing 11 and selectively disconnecting the power source 16 from the other components.

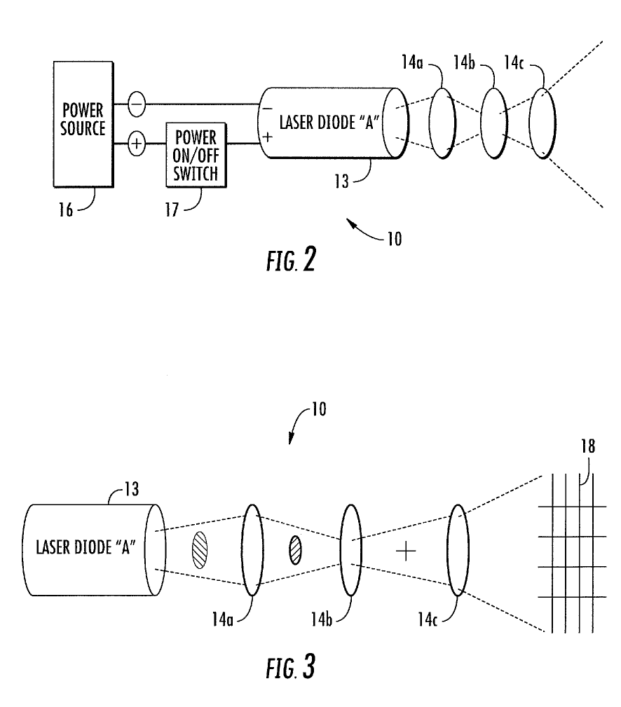

Referring additionally to FIGS. 2-3, the electronic device 10 illustratively includes a plurality of lenses 14a-14c arranged along an optical path. The plurality of lenses comprises a focusing lens 14a adjacent the optical source 13, a multiplier diffraction lens 14c, and a shape diffraction lens 14b between the focusing lens and the multiplier diffraction lens. In some embodiments, the order of the shape diffraction lens 14b and the multiplier diffraction lens 14c may be reversed, i.e. the multiplier diffraction lens may be between the focusing lenses 14a and the shape diffraction lens. The grid optical pattern 18 may comprise a plurality of cells arranged in columns and rows, illustratively shown as square cells, but other shapes (e.g. circle, diamond) could be used.

Another aspect is directed to a method of detecting movement with an electronic device 10. The method may comprise using at least one optical source 13 in the electronic device 10 for generating an optical output, and using at least one lens 14 in the electronic device for cooperating with the at least one optical source and projecting a grid optical pattern 18 from the optical output. The method may include using a video sensor 15 in the electronic device 10 for detecting changes in the grid optical pattern 18 caused by movement of an object O.

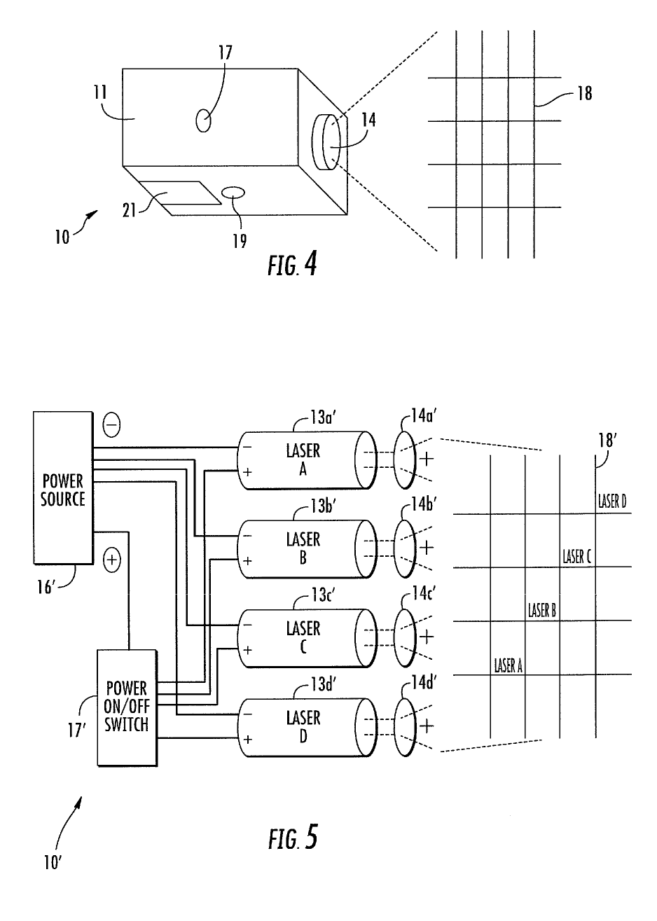

Referring now to FIG. 4, the electronic device 10 illustratively includes a tripod mount 19, thereby permitting easy stationary setup. For example, the tripod mount 19 may include a typical camera mount tripod threaded interface. Additionally, the electronic device 10 also illustratively includes a battery door compartment 21 on the external surface of the housing 11.

In other embodiments (not shown), the electronic device 10 may include a display and an input device, such as a control pad, for cooperating with the processor 12. In these embodiments, the processor 12 outputs the at least one characteristic of the object O on the display for a user to review. Indeed, in certain embodiments, the processor 12 may perform some low level rendering to provide the user with a representation of the object O based upon the distortions.

Referring now to FIG. 5, another embodiment of the electronic device 10′ is now described. In this embodiment of the electronic device 10′, those elements already discussed above with respect to FIGS. 1-4 are given prime notation and most require no further discussion herein. This embodiment differs from the previous embodiment in that the electronic device 10′ further includes a plurality of aligned optical sources 13a′-13d′, and a corresponding plurality of focusing lens 14a′-14d′, each focusing lens adjacent a respective optical source from the plurality thereof.

As will be appreciated by those skilled in the art, an exemplary implementation of the electronic device 10 is described. The exemplary implementation of the electronic device 10 may comprise the following:

### Component A—Laser Diode(s)

This unit may use one or more laser diodes to produce the laser light needed to project the grid pattern. These could be any color (spectral range), power (measured in mW), size or shape (including but not limited to crosses, lines, circles, dots, squares, etc.). These lasers may include a focusing lens or filters to change the power, color, focus, or pattern as needed. These lasers may be arranged to project a grid pattern.

### Component B—Laser Shape Diffraction Lens

A lens is attached to the output end of the laser module to turn a single dot projection into a shape. This can include, but not limited to, a cross, square, circle, star, etc.

### Component C—Laser Multiplier Diffraction Lens

A second lens is attached to the module (before or after “Component B” to multiply the shape into a pattern. This may create a multitude of shapes creating a desired pattern.

### Component D—Power Source

The diodes and power switch may be wired to a power source, which may be a battery pack or standard power source.

### Component E—Power Switch

A power switch may be used to toggle power to the laser diodes from the power sources whether via a battery pack or any other power source.

### Component F—Enclosure

An enclosure may be used to house the unit featuring an area for the laser diodes to project through, battery access and power switch. It may also be expanded to include any number of accessories including but not limited to a tripod mount, handle, stand, camera mount, lights, light emitting diode (LED) or liquid crystal display (LCD) screen for information display, motion sensor, heat sink, computer modules, or video modules for recording, etc.

The elements may include: laser diode(s); shape diffraction lens; multiplier diffraction lens; power source; toggle power switch; and enclosure. Elements that could be added include: a flexible stand for convenient direction adjustments; adjustment feature to allow the user to turn the lens which would adjust the pattern in numerous ways; tripod mount; motion sensor alarm; camera mount; handle; display screen for information display; software interaction for relaying information to a computer; software interaction for relaying information to an onboard memory card or hard drive; universal serial bus (USB) port for retrieving information from the unit or for computer or flash drive access; mechanism to be able to change patterns, color (spectral range) on the fly; and video recording ability.

The standard arrangement would include a single laser module (Component A) which projects a single dot through a focusing lens. This focused beam would go through an attached shape diffraction lens (Component B) to produce a shape. This shaped beam would then be sent through a multiplier diffraction lens (Component C) to multiply that shape to produce a pattern. This system would be embedded into one side of the enclosure with external exposure to project the light outward. This module would be wired to a power source and a toggle power switch located conveniently on the enclosure exterior.

The arrangement may include a single laser module (Component A), which projects a single dot through a focusing lens. This focused beam would go through an attached shape diffraction lens (Component B) to produce a shape. This shaped beam would then be sent through a multiplier diffraction lens (Component C) to multiply that shape to produce a pattern. This system would be embedded into one side of the enclosure with external exposure to project the light outward. This module may be wired to a power source and a toggle power switch located conveniently on the enclosure exterior.

Using one or more laser diodes, a focusing lens is attached to the end of the laser, and then, a shape producing lens is attached to create a shape from the single dot. From there, use a multiplier diffraction lens to multiply that shape into a pattern. Wire this whole system to power, toggle switch inside an enclosure.

One could use multiple shape producing laser modules wired together and aligned to produce a similar effect. This would eliminate the need for the multiplier diffraction lens. For example, four cross laser modules would be used to produce a 4×4 grid pattern. One could also use an animated laser system which uses single or multiple lasers moving quickly to make the projection look like a shape or pattern.

Setup the laser grid at a desired distance to project the grid pattern in any area you wish to survey or measure. Turn on the device and ensure it is placed properly to cover the entire area. When movement in the area of the projected grid occurs, the lines or pattern will be disturbed in some manner (broken, faded or misshaped) allowing for quick visual notice and location of the occurrence. Watch for movement or use surveillance cameras for review and analysis. By recording the occurrence you can later use the video to measure the three/two-dimensional dimensions, motion, shape, speed and mass of the subject.

For measurement and alignment of objects, place the laser grid a desired distance from the surface area. Level the unit and place it perpendicular to the surface for more accurate alignment. This will give you a lit pattern on the surface on which to place objects on the surface allowing for more accurate spatial alignment and spacing.

This unit would be helpful in any application where projecting grid pattern would be beneficial such as: simplification of aligning objects on a surface such as wallpaper, shelving, cabinets, tile, picture frames, siding, roofing, driveways, roads, etc.; measuring distance; and games: projecting a grid or like pattern onto a wall, table or floor could apply to many games such as Tic-Tac-Toe, card games, darts and more. This system utilizes multiple horizontal and vertical lines or other patterns combined to form a pattern for detecting movement in a large space or aligning and distribution of multiple objects with one setup and also to detect and monitor motion of the object.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An electronic device comprising:
at least one optical source generating an optical output;
at least one lens cooperating with said at least one optical source and projecting a grid optical pattern from the optical output; and
a video sensor detecting changes in the grid optical pattern caused by movement of an object.

2. The electronic device of claim 1 wherein the grid optical pattern comprises a plurality of cells arranged in columns and rows.

3. The electronic device of claim 1 further comprising a processor cooperating with said video sensor to determine at least one characteristic of the object based upon the changes in the grid pattern.

4. The electronic device of claim 3 wherein said processor determines a three-dimensional model of the object based upon the changes in the grid pattern.

5. The electronic device of claim 1 wherein said at least one lens comprises a plurality of lenses arranged along an optical path.

6. The electronic device of claim 5 wherein said plurality of lenses comprises a focusing lens adjacent said at least one optical source, a multiplier diffraction lens, and a shape diffraction lens between said focusing lens and said multiplier diffraction lens.

7. The electronic device of claim 1 wherein said at least one optical source comprises a plurality of aligned optical sources; and wherein said at least one lens comprises a corresponding plurality of focusing lens, each focusing lens adjacent a respective optical source from said plurality thereof.

8. The electronic device of claim 1 wherein said at least one optical source comprises a laser optical source.

9. The electronic device of claim 1 further comprising:
a housing carrying said at least one optical source, said at least one lens, and said video sensor;
a power source coupled to said at least one optical source and said video sensor, and also carried by said housing; and
a switch mounted onto an external surface of said housing and selectively disconnecting said power source.

10. An electronic device comprising:
a housing;
at least one laser source carried by said housing and generating an optical output;
at least one lens carried by said housing, and cooperating with said at least one laser source and projecting a grid optical pattern from the optical output, the grid optical pattern comprising a plurality of cells arranged in columns and rows; and
a video sensor carried by said housing and detecting changes in the grid optical pattern caused by movement of an object.

11. The electronic device of claim 10 further comprising a processor cooperating with said video sensor to determine at least one characteristic of the object based upon the changes in the grid pattern.

12. The electronic device of claim 11 wherein said processor determines a three-dimensional model of the object based upon the changes in the grid pattern.

13. The electronic device of claim 10 wherein said at least one lens comprises a plurality of lenses arranged along an optical path.

14. The electronic device of claim 13 wherein said plurality of lenses comprises a focusing lens adjacent said at least one laser source, a multiplier diffraction lens, and a shape diffraction lens between said focusing lens and said multiplier diffraction lens.

15. A method of detecting movement with an electronic device, the method comprising:
using at least one optical source in the electronic device for generating an optical output;
using at least one lens in the electronic device for cooperating with the at least one optical source and projecting a grid optical pattern from the optical output; and
using a video sensor in the electronic device for detecting changes in the grid optical pattern caused by movement of an object.

16. The method of claim 15 further comprising projecting the grid optical pattern comprising a plurality of cells arranged in columns and rows.

17. The method of claim 15 further comprising using a processor in the electronic device for cooperating with the video sensor to determine at least one characteristic of the object based upon the changes in the grid pattern.

18. The method of claim 17 further comprising determining a three-dimensional model of the object based upon the changes in the grid pattern.

19. The method of claim 15 wherein the at least one lens comprises a plurality of lenses arranged along an optical path.

20. The method of claim 19 wherein the plurality of lenses comprises a focusing lens adjacent the at least one optical source, a multiplier diffraction lens, and a shape diffraction lens between the focusing lens and the multiplier diffraction lens.

21. An electronic device comprising:
at least one optical source generating an optical output;
a focusing lens adjacent said at least one optical source; and
multiplier diffraction and shape diffraction lenses cooperating with said at least one optical source and said focusing lenses to project a grid optical pattern from the optical output.

22. The electronic device of claim 21 wherein the grid optical pattern comprises a plurality of cells arranged in columns and rows.

23. The electronic device of claim 21 wherein said at least one optical source comprises a laser optical source.

24. The electronic device of claim 21 further comprising:
a housing carrying said at least one optical source, said focusing, multiplier diffraction, and shape diffraction lenses;
a power source coupled to said at least one optical source and also carried by said housing; and
a switch mounted onto an external surface of said housing and selectively disconnecting said power source.

25. A method of operating an electronic device, the method comprising:
using at least one optical source to generate an optical output; and
using a focusing lens adjacent the at least one optical source, and multiplier diffraction and shape diffraction lenses cooperating with the at least one optical source and the focusing lenses to project a grid optical pattern from the optical output.

26. The method of claim 25 further comprising projecting the grid optical pattern comprising a plurality of cells arranged in columns and rows.

27. The method of claim 25 wherein the at least one optical source comprises a laser optical source.
